(19) United States
(12) Patent Application Publication
(10) Pub. No.: US 2023/0112957 A1
(43) Pub. Date: Apr. 13, 2023

(54) IMAGE DISPLAY METHOD AND ELECTRONIC DEVICE THEREOF

(71) Applicant: InnoLux Corporation, Miao-Li County (TW)

(72) Inventors: Yu-Chia HUANG, Miao-Li County (TW); Nai-Fang HSU, Miao-Li County (TW); Li-Wei SUNG, Miao-Li County (TW)

(21) Appl. No.: 17/930,133

(22) Filed: Sep. 7, 2022

(30) Foreign Application Priority Data
Oct. 12, 2021 (CN) 202111186614.X

(51) Int. Cl. G09G 3/00; G06F 3/01; G01C 21/36

(52) U.S. Cl. CPC G09G 3/001; G06F 3/013; G01C 21/3647; G09G 2380/10; G09G 2354/00; G09G 2320/068

(57) ABSTRACT

An image display method includes obtaining an image group, wherein the image group includes a plurality of images corresponding to multiple viewing angles; displaying a preset viewing-angle image, wherein the preset viewing-angle image is one of the images; and displaying the images within a predetermined time period continuously.

### CROSS REFERENCE TO RELATED APPLICATIONS

This application claims the benefit of China Application No. 202111186614.X, filed on Oct. 12, 2021, the entirety of which is incorporated by reference herein.

### BACKGROUND OF THE DISCLOSURE

### Field of the Invention

The present invention relates to an image display method and an electronic device, and, in particular, to an image display method and an electronic device capable of displaying images corresponding to multiple viewing angles.

### Description of the Related Art

In existing in-vehicle media applications, such as navigation applications, the in-vehicle display can display images of three-dimensional objects pertaining to the journey and the destination, such as buildings, intersections, scenic spots, and the like. However, although the in-vehicle can display 3D object images of the destination, the 3D object image may not match the actual scene as it is seen by the user, due to the difference in the user's route to the destination. In this case, the three-dimensional object images displayed on the in-vehicle display become unintuitive, which hinders the user's recognition of the landmark.

### BRIEF SUMMARY OF THE DISCLOSURE

An embodiment of the present disclosure provides an image display method. The image display method includes obtaining an image group, wherein the image group comprises a plurality of images corresponding to multiple viewing angles; displaying a preset viewing-angle image, wherein the preset viewing-angle image is one of the images; and displaying the images within a predetermined time period continuously.

An embodiment of the present disclosure provides an electronic device. The electronic device includes a controller, a control unit, and a display unit. The controller is configured to be operated by a driver. The control unit is configured to obtain an image group and a rotation angle of the controller. The image group includes a plurality of images corresponding to multiple viewing angles. The display unit is configured to display a preset viewing-angle image. The preset viewing-angle image is one of the images. The display unit continuously displays the images according to the rotation angle of the controller.

### BRIEF DESCRIPTION OF THE DRAWINGS

The disclosure can be more fully understood by reading the subsequent detailed description with references made to the accompanying figures. It should be understood that the figures are not drawn to scale in accordance with standard practice in the industry. In fact, it is allowed to arbitrarily enlarge or reduce the size of components for clear illustration. This means that many special details, relationships and methods are disclosed to provide a complete understanding of the disclosure.

FIG. 1 is a flow chart of an image display method in accordance with some embodiments of the present disclosure.

FIG. 2 is a schematic diagram of the structure of a vehicle electronic device in accordance with some embodiments of the present disclosure.

FIG. 3 is a schematic diagram of a plurality of images in accordance with some embodiments of the present disclosure.

FIG. 4A is a schematic diagram of an electronic device in a scene 340 in accordance with some embodiments of the present disclosure.

FIG. 4B is a schematic diagram of an electronic device in a scene 350 in accordance with some embodiments of the present disclosure.

FIG. 5 is a schematic diagram of line-of-sight coordinates corresponding to images in accordance with some embodiments of the present disclosure.

### DETAILED DESCRIPTION OF THE DISCLOSURE

In order to make the above purposes, features, and advantages of some embodiments of the present disclosure more comprehensible, the following is a detailed description in conjunction with the accompanying drawing.

Certain terms are used throughout the description and following claims to refer to particular components. As one skilled in the art will understand, electronic equipment manufacturers may refer to a component by different names. This document does not intend to distinguish between components that differ in name but not function. It is understood that the words “comprise”, “have” and “include” are used in an open-ended fashion, and thus should be interpreted to mean “include, but not limited to . . . ”. Thus, when the terms “comprise”, “have” and/or “include” used in the present disclosure are used to indicate the existence of specific technical features, values, method steps, operations, units and/or components. However, it does not exclude that more technical features, numerical values, method steps, work processes, units, components, or any combination of the above can be added.

The directional terms used throughout the description and following claims, such as: “on”, “up”, “above”, “down”, “below”, “front”, “rear”, “back”, “left”, “right”, etc., are only directions referring to the drawings. Therefore, the directional terms are used for explaining and not used for limiting the present disclosure. Regarding the drawings, the drawings show the general characteristics of methods, structures, and/or materials used in specific embodiments. However, the drawings should not be construed as defining or limiting the scope or properties encompassed by these embodiments. For example, for clarity, the relative size, thickness, and position of each layer, each area, and/or each structure may be reduced or enlarged.

When the corresponding component such as layer or area is referred to as being “on another component”, it may be directly on this other component, or other components may exist between them. On the other hand, when the component is referred to as being “directly on another component (or the variant thereof)”, there is no component between them. Furthermore, when the corresponding component is referred to as being “on another component”, the corresponding component and the other component have a disposition relationship along a top-view/vertical direction, the corresponding component may be below or above the other component, and the disposition relationship along the top-view/vertical direction is determined by the orientation of the device.

It should be understood that when a component or layer is referred to as being “connected to” another component or layer, it can be directly connected to this other component or layer, or intervening components or layers may be present. In contrast, when a component is referred to as being “directly connected to” another component or layer, there are no intervening components or layers present.

The electrical connection or coupling described in this disclosure may refer to direct connection or indirect connection. In the case of direct connection, the endpoints of the components on the two circuits are directly connected or connected to each other by a conductor line segment, while in the case of indirect connection, there are switches, diodes, capacitors, inductors, resistors, other suitable components, or a combination of the above components between the endpoints of the components on the two circuits, but the intermediate component is not limited thereto.

The words “first”, “second”, “third”, “fourth”, “fifth”, and “sixth” are used to describe components. They are not used to indicate the priority order of or advance relationship, but only to distinguish components with the same name.

It should be noted that the technical features in different embodiments described in the following can be replaced, recombined, or mixed with one another to constitute another embodiment without departing from the spirit of the present disclosure.

The electronic device in the present disclosure can be any suitable type of device, such as a touch display device, an antenna device, a tiled device, a sensing device, a flexible device, etc., but is not limited thereto. The electronic device described in the present disclosure is a touch display device with touch and display functions, and the display device may include liquid crystal (LC), light-emitting diode (LED), quantum dots (QDs), fluorescence, phosphor, other suitable materials or a combination of the above materials, but is not limited thereto. The light-emitting diode may include organic light-emitting diode (OLED), inorganic light-emitting diode, micro-LED, mini-LED, quantum dot light-emitting diode (QLED, QDLED), other suitable materials or a combination of the above materials, but is not limited thereto. The tiled device may be, for example, a tiled display device or a tiled antenna device, but is not limited thereto. In addition, the display device in the electronic device may be a color display device or a monochrome display device, and the shape of the electronic device may be rectangular, circular, polygonal, a shape with curved edges, or other suitable shapes. In addition, the electronic device described below uses, as an example, the sensing of a touch through an embedded touch device, but the touch-sensing method is not limited thereto, and another suitable touch-sensing method can be used provided that it meets all requirements.

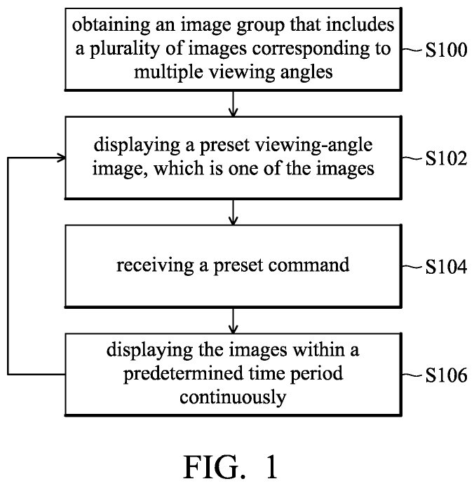

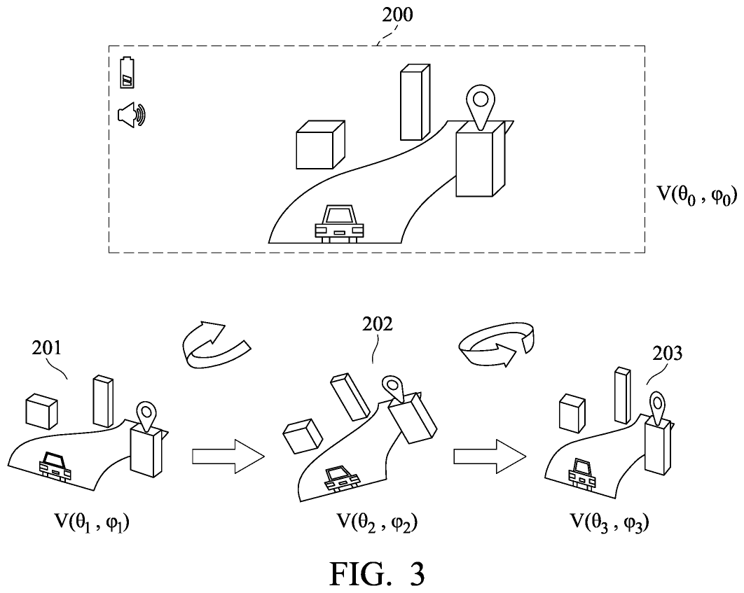

FIG. 1 is a flow chart of an image display method in accordance with some embodiments of the present disclosure. The image display method of the present disclosure includes obtaining an image group that includes a plurality of images corresponding to multiple viewing angles (step S100); displaying a preset viewing-angle image, which is one of the images (step S102); and after receiving a preset command (step S104), displaying the images within a predetermined time period continuously (step S106). It is noted that when observing a stereoscopic scene at a viewing angle, the observer can obtain an image corresponding to the viewing angle. In the present disclosure, the viewing angle can be represented by, for example, spherical coordinates, cylindrical coordinates, and rectangular coordinates, but the present disclosure is not limited thereto. For example, when the viewing angle is represented in spherical coordinates, the viewing angle may be defined, for example, by an azimuthal angle (θ) and a polar angle (φ). When the viewing angle changes (for example, the observer turns his head or changes the observation target), the appearance of respective object in the same scene may also generate a new corresponding image due to the change of the viewing angle. In addition, the “preset command” mentioned in some embodiments of the present disclosure may be the command for vehicle starting, turning, navigation setting, route changing, etc., or to manually activate the function of continuously displaying the images, but the present disclosure is not limited thereto. More specifically, after the time point when the vehicle is started, turned, the navigation setting is completed, the route is changed, or the function of continuously displaying the images is activated, the present disclosure may continuously display the images from the image group within a predetermined time period. In some embodiments, the preset command may come from a control unit 302 in FIG. 3, but the present disclosure is not limited thereto. The “predetermined time period” in some embodiments of the present disclosure may be, for example, 1 second to 10 seconds (1≤second predetermined time period≤10 seconds), but the present disclosure is not limited thereto.

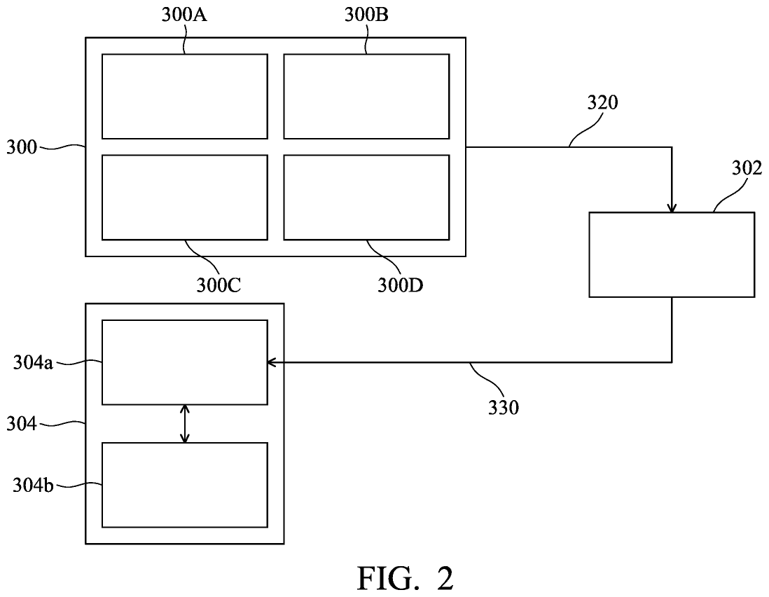

Please refer to FIG. 2. FIG. 2 is a schematic diagram of the structure of a vehicle electronic device in accordance with some embodiments of the present disclosure. In some embodiments, the image group in step S100 may be generated according to, for example, vehicle information provided by a sensor 300A (e.g., an infrared sensor or a laser sensor) in a controller 300, a camera 300B, a steering wheel rotation detector 300C, and a vehicle trip computer 300D, and messages provided by the navigation system , the cloud server, and/or the memory device (such as hard disk or memory), but the present disclosure is not limited thereto. The information can be sent to the control unit 302 through a signal 320. It is noted that the image group can be sent directly to the control unit 302 or generated by the control unit 302. For example, in some embodiments, a basic image can be captured through the camera. The control unit 302 generates images corresponding to multiple other viewing angles through calculation, and then forms an image group with the basic image and the multiple calculated images, and selects an image corresponding to the preset viewing angle for display. In some embodiments, the image group can be satellite photos from a cloud server or images collected in a cloud database, and these images can be sent directly to the control unit 302. The control unit 302 may include a central processing unit of the vehicle system, and may integrate such as memory, counter, universal serial bus (USB), analog-to-digital converter, universal asynchronous transceiver (UART), programmable logic controller (PLC), direct memory access (DMA), and other devices, different combination controls are done for different applications.

The display unit 304 receives the signal 330 provided by the control unit 302 to display the image group, and its operation will be described in the following paragraph.

FIG. 3 is a schematic diagram of a plurality of images in accordance with some embodiments of the present disclosure. Please refer to FIG. 1 and FIG. 3 at the same time. In step S102, the image display method of the present disclosure first displays a preset viewing-angle image 200 corresponding to a preset viewing angle. The viewing angle corresponding to the image 200 may be, for example, V(θ₀,φ₀). After that, after receiving the preset command, in the step S106, the image display method of the present disclosure sequentially displays an image 201, an image 202, and an image 203 with a predetermined time period. After the end of the predetermined time period, the image display method of the present disclosure redisplays the preset viewing-angle image 200. In some embodiments, the viewing angle corresponding to the image 201 may be, for example, V(θ₁,φ₁), the viewing angle corresponding to the image 202 may be, for example, V(θ₂,φ₂), and the viewing angle corresponding to the image 203 may be, for example, V(θ₃,φ₃). In some embodiments, the image display method of the present disclosure displays the images sequentially and continuously according to the corresponding viewing angles of the images (e.g., the preset viewing-angle image 200, and the images 201 to 203 in FIG. 3).

In some embodiments of FIG. 3, the viewing-angle relationship corresponding to the preset viewing-angle image 200 and the images 201 to 203 may be, for example, θ₀<θ₁<θ₂<θ₃ and φ₀<φ₁<φ₂<φ₃, but the present disclosure is not limited thereto. In some embodiments, one of the azimuth angle (θ) and the polar angle (φ) of the viewing angle corresponding to the image can be a constant value, that is, θ₀=θ₁=θ₂=θ₃ and φ₀=φ₁=φ₂=φ₃. In some embodiments of FIG. 3, the viewing-angle difference corresponding to the adjacent images may be less than a first angle. For example, when the first angle is 10 degrees, the relationship between the viewing angles may be 0≤θ₁−θ₀<10 degrees, 0≤θ₂−θ₁<10 degrees, 0≤θ₃−θ₂<10 degrees, 0≤φ₁−φ₀<10 degrees, 0≤φ₂−φ₁<10 degrees, and 0≤φ₃−φ₂<10 degrees. In some embodiments of FIG. 3, for the two images in the image group corresponding to the largest viewing angle and the smallest viewing angle, the viewing-angle difference corresponding to the two images is less than a second angle. For example, when the second angle is 30 degrees, then the relationship between the viewing angles may be θ₃−θ₀<30 degrees and φ₃−φ₀<10 degrees. In some embodiments, the second angle (e.g., 30 degrees) is larger than the first angle (e.g., 10 degrees).

In some embodiments, step S106 executed by the image display method of the present disclosure can assist a user (e.g., a driver) to create a stereoscopic experience. After completing step S106, the image display method of the present disclosure finally displays back the preset viewing-angle image 200. That is, after completing step S106, the image display method of the present disclosure executes step S102 again. Until a new preset command is received again (step S104), a plurality of consecutive images corresponding to different viewing angles are output again (step S106). It is noted that, in some embodiments, when the vehicle receives the preset command (step S104) and outputs consecutive images corresponding to multiple viewing angles (step S106), and the image display method returns to the step of redisplaying the preset viewing-angle images (step S102), the displayed image may be different from the preset viewing-angle image before receiving the preset command. For example, first, the image corresponding to the preset viewing-angle is the image that the driver sees when he is looking straight ahead. After the vehicle turns and starts to output consecutive images corresponding to multiple viewing angles, and finally the preset viewing angle is returned back(that is, the driver is looking straight ahead), the image seen by the driver is already different from the image, corresponding to the preset viewing angle, presented before the turn.

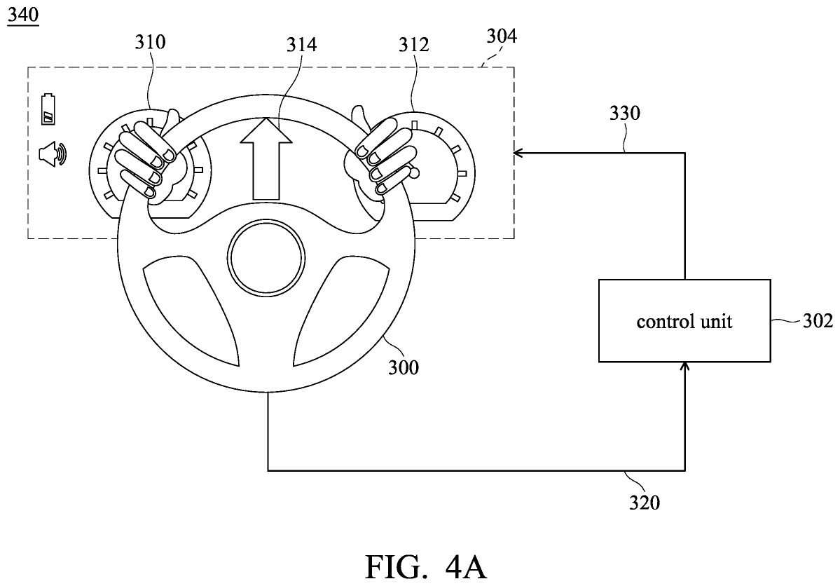

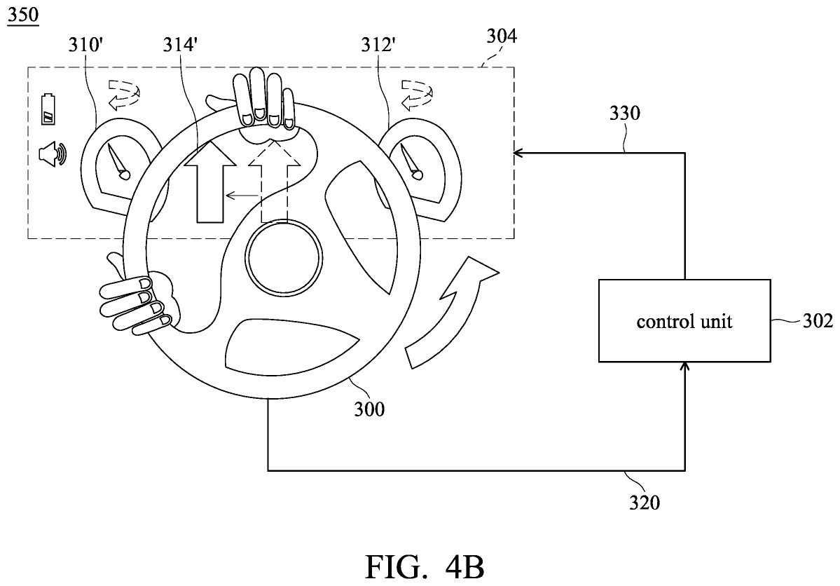

FIG. 4A is a schematic diagram of an electronic device in a scene 340 in accordance with some embodiments of the present disclosure. As shown in FIG. 4A, the electronic device of the present disclosure includes a controller 300, a control unit 302, and a display unit 304. The controller 300 is operated by a driver. In some embodiments, the controller 300 may include, for example, an electronic steering wheel, but the present disclosure is not limited thereto. The controller can send information of its rotation angle to the control unit 302 through a signal 320. The control unit 302 can obtain at least one image group corresponding to multiple different viewing angles, and obtain the rotation angle of the controller 300 through the signal 320.

As shown in FIG. 2, the display unit 304 may include a display controller 304a and a display panel 304b for displaying an image corresponding to a preset viewing angle (e.g. the image 200 in FIG. 3). The image corresponding to the preset viewing angle is one image in the image group. As described above, in some embodiments, the control unit 302 may calculate and generate other images in the mage group according to a base image in the image group. The control unit 302 can further send the images corresponding to different viewing angles in the image group to the display unit 304 through a signal 330.

Furthermore, the display unit 304 can continuously display images according to the rotation angle of the controller 300. For example, in some embodiments, the display controller 304a is used for controlling the display panel 304b to display images corresponding to multiple viewing angles according to the image information from the control unit 302. For example, the display unit 304 may receive a first image group including an image 310, a second image group including an image 312, and a third image group including an image 314 from the control unit 302. As shown in FIG. 4A, the first image group corresponds to the instrument on the left, the second image group corresponds to the instrument on the right, and the third image group corresponds to the arrow instrument located between the two instruments.

In the scene 340 of FIG. 4A, the rotation angle of the controller 300 is 0 degree. Therefore, when the display unit 304 (e.g., the display controller) receives the rotation angle information (e.g., 0 degree) of the controller 300 from the control unit 302, the display unit 304 can correspondingly display the images corresponding to rotation angle 0 degree in the first image group, the second image group, and the third image group. For example, the images may be the image 310, the image 312, and the image 314.

FIG. 4B is a schematic diagram of an electronic device in a scene 350 in accordance with some embodiments of the present disclosure. As shown in FIG. 4B, in the scene 350 of FIG. 4B, the rotation angle of the controller 300 is 45 degrees to the left. Therefore, when the display unit 304 (e.g., the display controller) receives the rotation angle information (e.g., 45 degrees) of the controller 300 from the control unit 302, the display unit 304 can correspondingly display an image 310′ and an image 312′. The image 310′ and the image 310 are images of the same object (such as the instrument on the left) corresponding to different viewing angles, that is, they belong to the first image group. The viewing angle corresponding to the image 310′corresponds to the rotation angle of the controller 300. The image 312′ and the image 312 are images of the other object (such as the instrument on the right) corresponding to different viewing angles, that is, they belong to the second image group. The viewing angle corresponding to the image 312′corresponds to the rotation angle of the controller 300.

In some embodiments, when the display unit 304 receives any rotation angle of the controller 300 from the control unit 302, the display unit 304 starts to continuously display the images in the first image group (e.g., the images 310 and 310′), and continuously displays the images in the second image group (e.g., the images 312 and 312′). In some embodiments, after the display unit 304 finishes continuously displaying the images in the first image group and the second image group, the display unit 304 finally displays the images corresponding to the preset viewing angle (e.g., the images 310 and 312 in FIG. 4A). In some embodiments of FIG. 4B, the display unit 304 further changes the image 314 of FIG. 4A to the image 314′ correspondingly according to the rotation angle of the controller 300 (for example, 45 degrees to the left), so that the arrow illustration is moved from the initial position shown in image 314 to the new position shown in image 314′, and the arrow illustration is not blocked by the controller 300 among the driver's sight.

In some embodiments, the image display method of the present disclosure further includes obtaining line-of-sight coordinates of a driver; extracting one of the images corresponding to the line-of-sight coordinates from the image group; and displaying the image corresponding to the line-of-sight coordinates. In other words, in some embodiments, the control unit 302 may, for example, obtain the line-of-sight coordinates of the driver through an eye tracking technology. The display unit 304 displays an image corresponding to the line-of-sight coordinates.

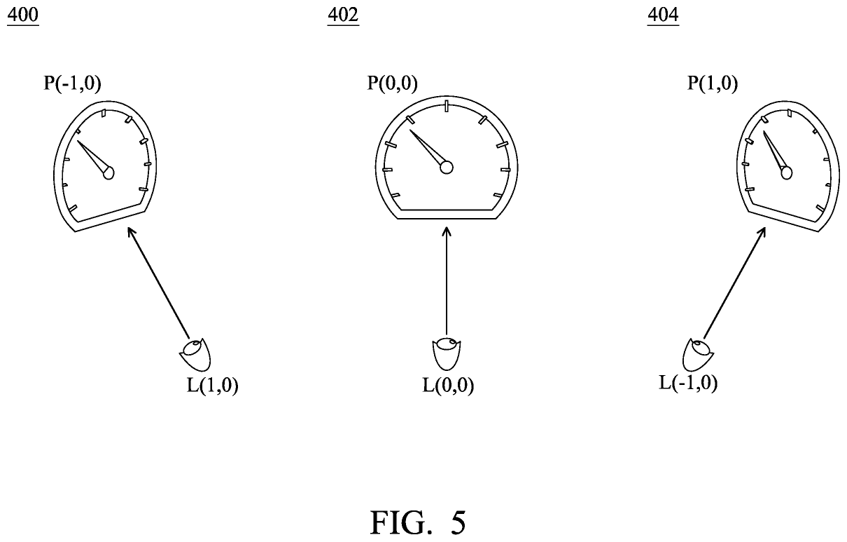

Please refer to FIG. 4B and FIG. 5. FIG. 5 is a schematic diagram of line-of-sight coordinates corresponding to images in accordance with some embodiments of the present disclosure. As shown in FIG. 5, in scene 400, when the control unit 302 obtains the light-of-sight coordinates L(1,0), the control unit 302 extracts an image P(−1,0) corresponding to the light-of-sight coordinates L(1, 0) from the image group according to the light-of-sight coordinates L(1,0), and the image P(−1,0) is displayed by the display unit 304.

Similarly, in scene 402 of FIG. 5, when the control unit 302 obtains the light-of-sight coordinates L(0,0), the control unit 302 extracts an image P(0,0) corresponding to the light-of-sight coordinates L(0,0) from the image group according to the light-of-sight coordinates L(0,0), and the image P(0,0) is displayed by the display unit 304. Similarly, in scene 404 of FIG. 5, when the control unit 302 obtains the light-of-sight coordinates L(−1,0), the control unit 302 extracts an image P(1,0) corresponding to the light-of-sight coordinates L(−1,0) from the image group according to the light-of-sight coordinates L(−1,0), and the image P(1,0) is displayed by the display unit 304.

In some embodiments of FIG. 5, the image group stores the following Table 1.

TABLE 1

| | images | light-of-sight coordinates |
|---|---|---|
| status 1 | P(−1, 0) | L(1, 0) |
| status 2 | P(0, 0) | L(0, 0) |
| status 3 | P(1, 0) | L(−1, 0) |
| . . . | . . . | . . . |
| . . . | . . . | . . . |
| status N | P(m, n) | L(xm, yn) |

In some embodiments of FIG. 5, the scene 400 matches status 1 in Table 1, the scene 402 matches status 2 in Table 1, and the scene 404 matches status 3 in Table 1. The correspondence between the light-of-sight coordinates and the images in Table 1 is only an example, and the present disclosure is not limited thereto.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image display method, comprising:
obtaining an image group, wherein the image group comprises a plurality of images corresponding to multiple viewing angles;
displaying a preset viewing-angle image, wherein the preset viewing-angle image is one of the images; and
displaying the images within a predetermined time period continuously.

2. The image display method as claimed in claim 1, wherein the predetermined time period begins at a time point when a vehicle is started.

3. The image display method as claimed in claim 1, wherein the predetermined time period begins at a time point when a navigation setting is completed.

4. The image display method as claimed in claim 1, wherein the predetermined time period begins at a time point when a route is changed.

5. The image display method as claimed in claim 1, wherein the predetermined time period begins at a time point when a user manually activate continuous display of the images.

6. The image display method as claimed in claim 1, further comprising:
displaying back the preset viewing-angle image after the images are continuously displayed.

7. The image display method as claimed in claim 1, wherein the images comprise a plurality of images corresponding to the multiple viewing angles in one scene.

8. The image display method as claimed in claim 1, wherein the operation of continuously displaying the images comprises:
displaying the images sequentially and continuously according to the viewing angles corresponding to the images.

9. The image display method as claimed in claim 8, wherein a viewing-angle difference corresponding to the adjacent images is less than 10 degrees.

10. The image display method as claimed in claim 1, further comprising:
obtaining line-of-sight coordinates of a driver;
extracting one of the images corresponding to the line-of-sight coordinates from the image group; and
displaying the one of the images corresponding to the line-of-sight coordinates.

11. The image display method as claimed in claim 8, wherein a viewing-angle difference corresponding to the two images in the image group having the largest viewing angle and the smallest viewing angle is less than 30 degrees.

12. The image display method as claimed in claim 1, further comprising:
receiving a preset command; and
displaying the images within the predetermined time period continuously according to the preset command.

13. The image display method as claimed in claim 12, wherein the preset command is the command for vehicle starting, turning, navigation setting, route changing, or to manually activate the function of continuously displaying the images.

14. The image display method as claimed in claim 1, wherein the predetermined time period is 1 second to 10 seconds.

15. An electronic device, comprising:
a controller, configured to be operated by a driver;
a control unit, configured to obtain an image group and a rotation angle of the controller, wherein the image group comprises a plurality of images corresponding to multiple viewing angles; and
a display unit, configured to display a preset viewing-angle image, wherein the preset viewing-angle image is one of the images;
wherein the display unit continuously displays the images according to the rotation angle of the controller.

16. The electronic device as claimed in claim 15, wherein the controller comprises a sensor, a camera, a steering wheel rotation detector, and a vehicle trip computer.

17. The electronic device as claimed in claim 16, wherein the image group is generated according to vehicle information provided by the sensor, the camera, the steering wheel rotation detector, and the vehicle trip computer.

18. The electronic device as claimed in claim 15, wherein the image group is sent directly to the control unit or generated by the control unit.

19. The electronic device as claimed in claim 15, wherein the display unit comprises a display controller and a display panel.

20. The electronic device as claimed in claim 19, wherein the display controller controls the display panel to display the images corresponding to multiple viewing angles according to the images from the control unit.
